(19) United States
(12) Patent Application Publication
(10) Pub. No.: US 2014/0141775 A1
(43) Pub. Date: May 22, 2014

(54) METHOD OR SYSTEM TO SEARCH WHEN MOVING OR STANDING STILL FOR 802.11 WIRELESS NETWORKS, TO THEN SEND OR RECEIVE GPS AND OTHER INFORMATION USING 802.11 WIRELESS NETWORKS TO A WEB PORTAL OR SOFTWARE APPLICATION

(71) Applicant: Vincent Nicosia, Phoenix, AZ (US)

(72) Inventor: Vincent Nicosia, Phoenix, AZ (US)

(21) Appl. No.: 13/678,852

(22) Filed: Nov. 16, 2012

(51) Int. Cl. H04W 48/16

(52) U.S. Cl. CPC H04W 48/16
USPC 455/434

(57) ABSTRACT

A method or system that when moving or standing still searches and connects to 802.11 wireless networks to then send GPS or other information and receive data or software or information from an internet web service or software application. The method or device or software searches for many types of 802.11 Wi-Fi networks, then connects to send and receive information to a web service or software application. This method or system describes four of the most common types of 802.11 network connections in claims 2 thru 5.

### FIELD OF THE INVENTION

The present invention relates to a method or system for searching and connecting to 802.11 wireless networks while moving or standing still. Once it has connected to a 802.11 network it sends and receives GPS data, software, information and data to a web service or software application.

### BACKGROUND

Present day GPS devices use cellular or satellite networks to send and receive data. Each of these GPS systems are designed specifically for manufacture's cellular or satellite network. Due to this they have a high overall cost of operation. These systems while moving or standing still do not search for and utilize 802.11 Networks that may be in range.

### SUMMARY OF THE INVENTION

The invention will reduce GPS systems operational cost by leveraging 802.11 Wi-Fi Networks. Hence, in a first aspect there is a method for connecting to 802.11 Wi-Fi Networks while moving or standing still. When moving the method or system searches for 802.11 Wi-Fi Networks that are in range. Once it locates 802.11 Wi-Fi Networks that are in range it can uses many methods to connect the invention describes four of the most common methods to connect.

In the next aspect of the method or system once an 802.11 Wi-Fi network is in range it connect and then send GPS and other data to a web service or software application. The web service or software application can then send data, software, information and instructions.

### BRIEF DESCRIPTION OF THE DRAWINGS

Having thus described the invention in general terms, reference will now be made to the accompanying drawings, which are not necessarily drawn to scale, and wherein:

FIG. 1 is a flow chart illustrating a number of steps of a method according to the embodiments of the present method or system. FIG. 1 shows the flow of the method or system of this invention. From left to right of drawing the first box describes the method or system searching for while moving or standing still. Once it has located a new 802.11 Wi-Fi network in range the next box is the method or system utilizing one of the four methods or systems described in the system or method claims to connect to 802.11 Wi-Fi networks. The third box on the top row and right of the drawing is the web service or software application that sends and receives data, software, information as part of the method or process. The first box of the second row of the drawing is the web service or software application that the user or customer interacts with to see or manage the service. The second box on the bottom row and right of the drawing is the device or software application described in the method or system which receives and send to the web service or software application data, software, or information.

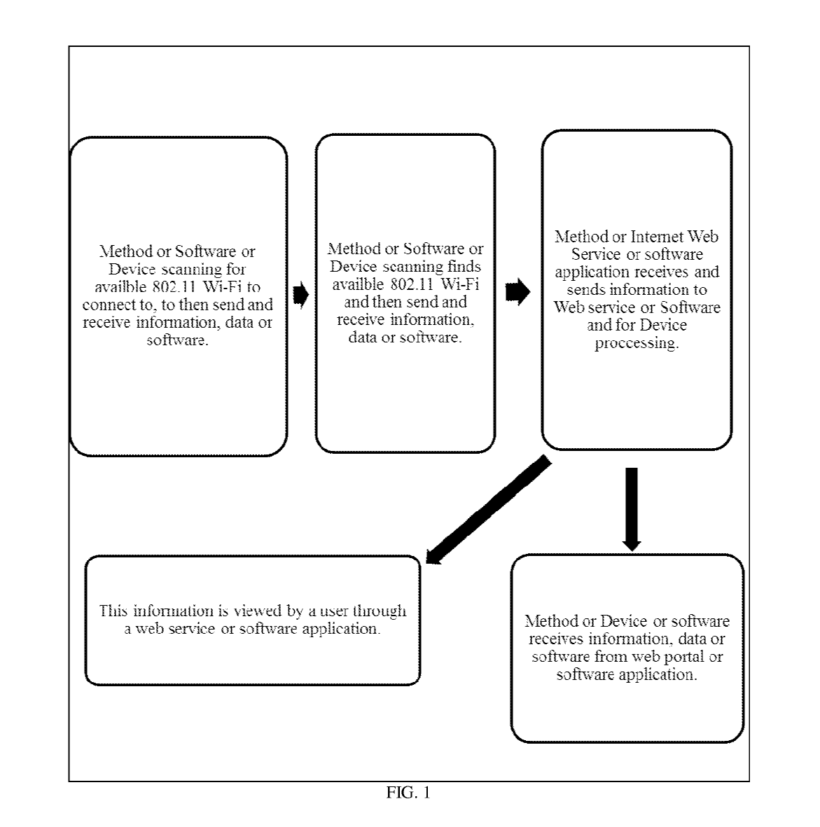

1. A method or system that when moving or standing still, searches and connects to available 802.11 Wi-Fi networks to then send or receives GPS information or data like speed, latitude and longitude, direction, and any other data or software applications. The method or system when moving or standing still, searches for many types of 802.11 Wi-Fi networks. This method or system describes four of the most common types of connections in claims 2 thru 5, to send and receive data, software or information to or from a web service or software application using 802.11 Wi-Fi networks.

2. The method or system according to claim 1, connects using this type of available 802.11 Wi-Fi networks for any method, system, software applications or devices. Commonly referred to “Open Wi-Fi Hot Spot.”

3. The method or system according to claim 1, connects using available 802.11 Wi-Fi networks that have passwords, these 802.11 Wi-Fi networks are available to all Customers or Users of the methods, systems, software application or devices. Commonly referred to as “Public Wi-Fi with Password Protection.”

4. The method or system according to claim 1, connects using available private 802.11 Wi-Fi networks with passwords that a Customers or User of the method or system has access to, to be used by Customer or User's of the method or system. Commonly referred to as “Private Wi-Fi with Password Protection”

5. The method or system according to claim 1, connects using available private 802.11 Wi-Fi networks that a Customer or User has access to like 802.11 Wi-Fi enabled phones or home 802.11 Wi-Fi networks with or without passwords for use by Customer or User's of the method or system. Commonly referred to as “Private User Wi-Fi with Password Protection.”
